(19) United States
(12) Patent Application Publication
(10) Pub. No.: US 2009/0097247 A1
(43) Pub. Date: Apr. 16, 2009

(54) LED LAMP

(76) Inventors: Jui-Huang Tseng, Jhonghe City (TW); Chia-Li Chen, Jhonghe City (TW)

Correspondence Address: HDLS Patent & Trademark Services, P.O. BOX 220746, CHANTILLY, VA, 20153-0746, US

(21) Appl. No.: 12/244,129

(22) Filed: Oct. 2, 2008

(30) Foreign Application Priority Data
Oct. 12, 2007 (TW) 096138244

(51) Int. Cl. F21V 7/00

(52) U.S. Cl. 362/241

(57) ABSTRACT

A light emitting diode (LED) lamp includes a lamp casing and an illuminating device. The lamp casing includes a containing space and two asymmetric first and second reflecting portions in the lamp casing. The first and second reflecting portions are reflecting surfaces with a specific curvature. The illuminating device is installed in the containing space and includes a first LED light source and a second LED light source facing the reflecting surfaces of the first and second reflecting portions respectively, such that lights projected by the first and second LED light sources are reflected by their corresponding reflecting surfaces to define an illuminating range covering angles of two different light beams.

### BACKGROUND OF THE INVENTION

1. Field of the Invention

The present invention generally relates to a light emitting diode (LED) lamp, and more particularly to a design of LED lamp that adopts two groups of LED light sources and two asymmetric reflecting portions to provide illuminations with two different illuminating angles, and such LED lamp is applicable for automobile lamps and spot lights.

2. Description of Prior Art

As science and technology advance rapidly, conventional light sources used for illumination are gradually replaced by light emitting diodes (LED). Since LED comes with a high brightness, a small size and an environmental protection advantage, therefore LED is used extensively as a light source of personal digital products, traffic facilities, automobile lamps, and construction illuminations, etc.

At present, the research and development of LED focus on the enhancement of brightness, and the design is limited to a lamp illumination with a specific range of angles. Taking an automotive lamp for example, traditional LEDs are used as the light sources of a high beam lamp and a low beam lamp of a motor vehicle. Since LED has the feature of emitting light in 180 degrees, and projects a light directly to the front, and a reflecting portion (or cup) receives lights of a large illuminating angle to define an illuminating range of a fixed angle. However, such design has a drawback that the high beam lamp and the low beam lamp cannot share the same lamp cup. In other words, two lamp cup modules are required for providing two different illuminating ranges, and the same applies to LED lamps in other applications, and thus the aforementioned issue must be taken into consideration for the overall spatial layout of the structure.

### SUMMARY OF THE INVENTION

It is a primary objective of the present invention to provide an LED lamp with an illuminating range covering angles of two different light beams.

To achieve the foregoing objective, the present invention provides an LED lamp comprising a lamp casing and an illuminating device, wherein the lamp casing has a containing space and two asymmetric first and second reflecting portions in the lamp casing, and the first and second reflecting portions are reflecting surfaces with a specific curvature. The illuminating device is installed in the containing space and includes a first LED light source and a second LED light source for separate illuminations, wherein the first and second LED light sources face towards the reflecting surfaces of the first and second reflecting portions respectively, such that light projected from the first and second LED light sources is reflected by their corresponding reflecting surfaces to define an illuminating range covering angles of two different light beams.

To make it easier for our examiner to understand the present invention, we use preferred embodiments with related drawings for the detailed description of the present invention as follows:

### BRIEF DESCRIPTION OF DRAWINGS

FIG. 1 is a perspective view of a preferred embodiment of the present invention;

FIG. 2 is a cross-sectional view of a preferred embodiment of the present invention;

FIG. 2A is a cross-sectional view of a reflecting surface which is a non-smooth surface with concave and convex lines in accordance with a preferred embodiment of the present invention;

FIG. 3 is a schematic view of a first LED light source uses as a light source of a high-beam lamp in accordance with a preferred embodiment of the present invention; and

FIG. 4 is a cross-sectional view of a second LED light source used as a light source of a low-beam lamp in accordance with a preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

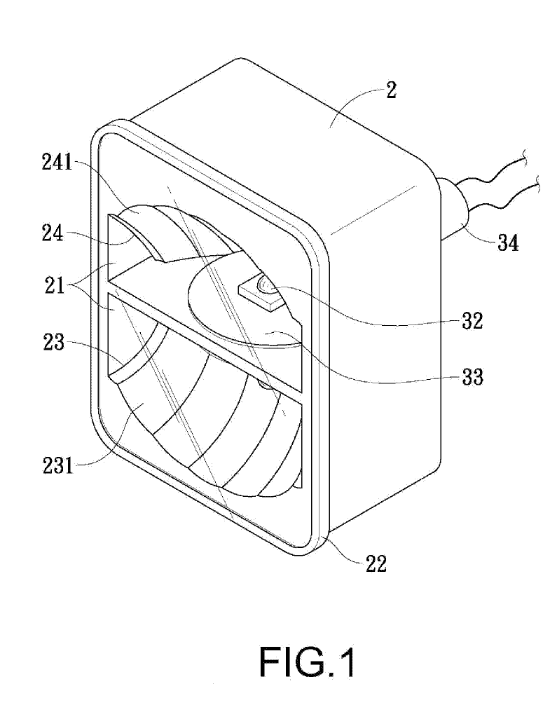

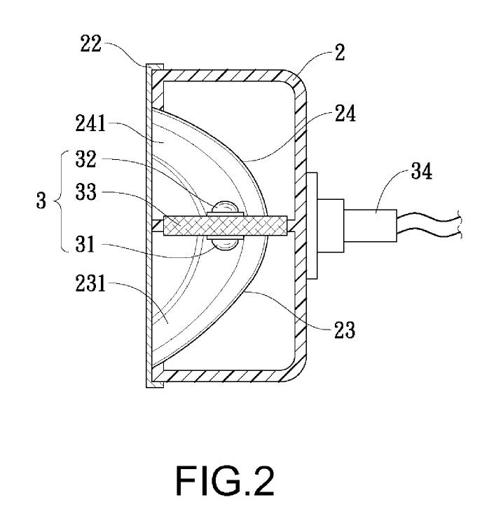

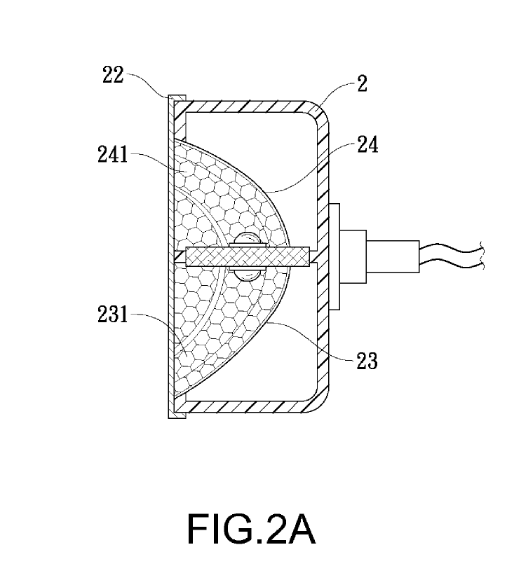

With reference to FIGS. 1 and 2 for an LED lamp 1 in accordance with a preferred embodiment of the present invention, the LED lamp 1 comprises a lamp casing 2 and an illuminating device 3.

The lamp casing 2 has a containing space 21, a lamp cup 22 combined with a distal surface of the lamp casing 2, and two asymmetric first and second reflecting portions 23, 24 in the lamp casing 2, wherein the first and second reflecting portions 23, 24 have reflecting surfaces 231, 241 with a specific curvature, respectively.

The illuminating device 3 is installed in the containing space 21 and includes a first LED light source 31 and a second LED light source 32 for separate illuminations, wherein the first and second LED light sources 31, 32 face towards the reflecting surfaces 231, 241 of the first and second reflecting portions 23, 24, respectively, such that the lights projected from the first and second LED light sources 31, 32 can be reflected by their corresponding reflecting surfaces 231, 241 to define an illuminating range covering angles of two different light beams. The illuminating device 3 further includes a heat dissipating device 33 connected to the first LED light source 31 and the second LED light source 32, and a power supply device 34 for providing a power supply 32 to the first LED light source 31 and the second LED light source.

With reference to FIGS. 1 to 4, the first and second reflecting portions 23, 24 are designed with a desired curvature according to user's requirements to achieve the required intensity of light beams at different angles, such that the illuminating range of a light projected from the first LED light source 31 and reflected from the reflecting surface 231 of the first reflecting portion 23 is much farther than the illuminating range of a light projected from the second LED light source 32 and reflected from the reflecting surface 241 of the second reflecting portion 24, and the reflecting surfaces 231, 241 of the first and second reflecting portions 23, 24 are smooth surfaces with a specific curvature, or non-smooth surfaces with concave and convex lines (as shown in FIG. 2A).

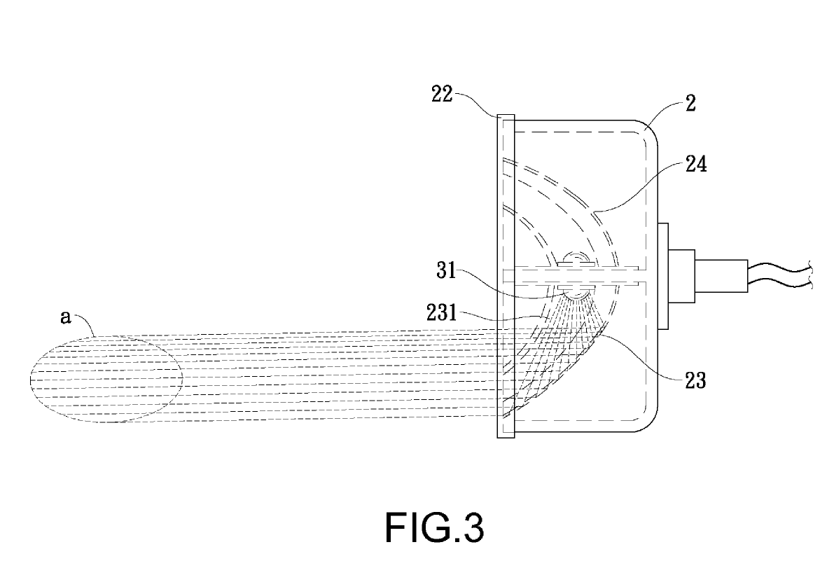

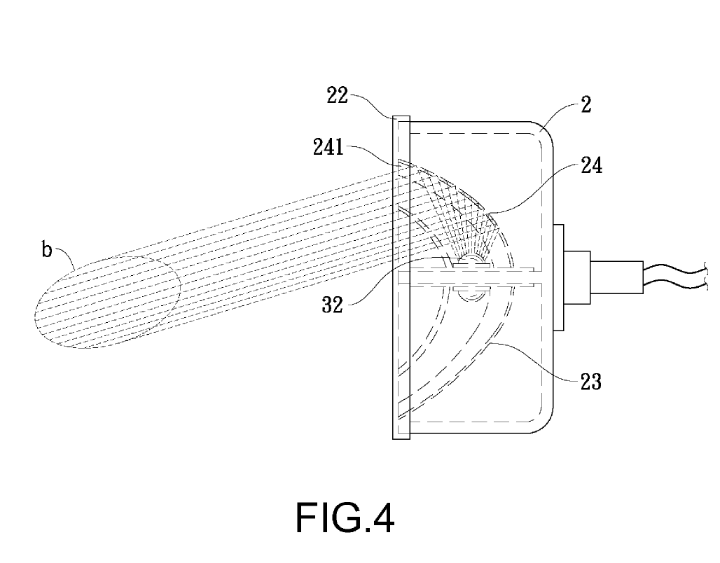

When the LED lamp of the invention is applied to an automobile and used as the high and low beam lights, two asymmetric first and second reflecting portions 23, 24 are designed in the lamp casing 2, and reflecting surfaces 231, 241 with a specific curvature are designed on the first and second reflecting portions 23, 24 according to the an illuminating range covering angles of the high and low beams, such that the illuminating range a of a light projected from the first LED light source 31 and reflected from the reflecting surface 231 of the first reflecting portion 23 is much farther than the illuminating range b of a light projected from the second LED light source 32 and reflected from the reflecting surface 241 of the second reflecting portion 24, and first LED light source 31 serves as the light source of the high beam light (as shown in FIG. 3), and the second LED light source 32 serves as the light source of the low beam light (as shown in FIG. 4).

In the present invention, two LED light sources and two asymmetric reflecting portions are designed in a lamp casing to provide an LED lamp with an illuminating range covering the angles of two different light beams. The invention has the advantages of simple structure, low cost, and applicable for the use in automobile lamps and spot lights.

In summation of the description above, the present invention provides an LED lamp that can achieve the expected objectives and comply with the patent application requirements, and thus is duly file for patent application.

While the invention is described by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A light emitting diode (LED) lamp, comprising:
a lamp casing, having a containing space, and two asymmetric first and second reflecting portions disposed therein, and the first and second reflecting portions having a reflecting surface with a specific curvature;
an illuminating device, installed in the containing space, and including a first LED light source and a second LED light source for separate illuminations, and each of the first and second LED light sources facing towards reflecting surface of the first and second reflecting portions, such that light projected by the first and second LED light sources respectively is reflected from the corresponding reflecting surfaces to define an illuminating range covering angles of two different light beams.

2. The lamp of claim 1, wherein the illuminating device comprises a heat dissipating device connected to the first LED light source and the second LED light source, and a power supply device for supplying electric power to the first LED light source and the second LED light source.

3. The lamp of claim 1, wherein the lamp casing includes a lamp cup combined with a distal surface of the lamp casing.

4. The lamp of claim 1, wherein the light projected by the first LED light source and reflected from the reflecting surface of the first reflecting portion has an illuminating range much farther than the illuminating range of a light projected by second LED light source and reflected from the reflecting surface of the second reflecting portion.

5. The lamp of claim 4, wherein the reflecting surfaces of the first and second reflecting portions are smooth surfaces with a specific curvature.

6. The lamp of claim 4, wherein the reflecting surfaces of the first and second reflecting portions are non-smooth surfaces with concave and convex lines.

7. The lamp of claim 1, wherein the reflecting surfaces of the first and second reflecting portions are smooth surfaces with a specific curvature.

8. The lamp of claim 1, wherein the reflecting surfaces of the first and second reflecting portions are non-smooth surfaces with concave and convex lines.
